(19) United States
(12) Patent Application Publication
(10) Pub. No.: US 2012/0020297 A1
(43) Pub. Date: Jan. 26, 2012

(54) MOBILE HANDHELD FOR VOICE COMMUNICATION OVER THE INTERNET

(76) Inventor: Albert Cecchini, Jamestown, NY (US)

(21) Appl. No.: 13/189,133

(22) Filed: Jul. 22, 2011

Related U.S. Application Data
(60) Provisional application No. 61/400,312, filed on Jul. 23, 2010.

(51) Int. Cl. H04W 88/02

(52) U.S. Cl. 370/328

(57) ABSTRACT

A mobile handheld device implements VoIP over IP wireless networks, such as Wi-Fi or WiMAX, by connecting a WNIC to a peripheral receptacle, such as a USB receptacle, that is hardwired to components of the handheld. The WNIC is not hardwired into the handheld, rather just the receptacle is hardwired to the handheld.

### CROSS REFERENCE TO RELATED APPLICATIONS

This application claims benefit of U.S. Provisional Application No. 61/400,312, filed Jul. 23, 2010. The contents of that application are hereby incorporated by reference.

### TECHNICAL FIELD

The present invention relates to mobile handheld telephones and personal digital assistants (PDAs) with Voice over Internet Protocol (VoIP) capabilities.

### BACKGROUND

Current mobile internet providers offer data plans for internet access as well as voice plans both of which are required for handheld mobile telephone devices. Additionally, many handheld mobile cellular devices only support a single mobile service provider, so the voice and data plans must be purchased from the same provider. With the advent of VoIP, standard internet connections currently support and provide voice and video IP communications between two or more parties either individually or simultaneously. The need exists for a handheld mobile device that is designed to plug in Internet Protocol (IP) transceivers from many service providers and then to use the Internet connection facilitated by such to establish VoIP sessions. In this way, the user would not have to be restricted to a single telecommunications service provider and would not be required to pay an additional cellular voice fee. In addition, such users would also be able to use the same mobile IP transceiver with all of their devices such as a computer, electronic pad, and the like for a single cost.

VoIP is a group of transmission technologies for facilitating voice communications over Internet Protocol networks (IP networks), such as the Internet or other packet-switched networks. VoIP is also known as Internet Protocol telephony, Internet telephony, voice over broadband, broadband telephony, and broadband phone. VoIP has two basic steps: converting an analog voice signal to digital format and processing the signal, which includes compression and translation of the signal into Internet protocol (IP) packets for transmission of the signal over the Internet. The process is reversed for receiving the signal as IP packets. One method of implementation includes using the mobile handhelds as a Session Initiation Protocol (SIP) client, which uses a data network to communicate SIP messaging and Real-time Transmission Protocol (RTP) for voice. VoIP protocols (e.g. SIP) can be implemented over IP wireless networks, such as Wi-Fi or WiMAX. For example, in the summer of 2006, Nokia introduced a SIP VoIP client in a Nokia E-series dual-mode Wi-Fi handheld.

Currently, mobile handhelds that implement SIP have a hardwired wireless network interface controller/card (WNIC) that enables the VoIP. A WNIC is any network card that connects to a radio-based (i.e. wireless) computer network, as opposed to a network interface controller that connects to a wired network such as Ethernet. Having the WNIC fixed is advantageous in that it enables smaller mobile handhelds and sleeker designs. Moreover, a fixed WNIC is more convenient for users of a mobile handheld. However, usually handhelds with fixed WNIC devices are designed to restrict the device for use through a single telecommunications service provider. Such handhelds are also designed to have the users communicate mostly through cellular protocols instead of VoIP. Having both a WNIC and circuitry for cellular communications in a single handheld device increases the cost, weight and size of the devices unnecessarily. In addition, there is redundancy in such handheld devices to users that already have a WNIC for their computer.

### SUMMARY

Described herein is an implementation of a mobile handheld that overcomes the restrictions such as redundancy, high plan cost, high device cost, higher device size and weight, and higher device maintenance cost, associated with hardwiring a WNIC to a mobile handheld.

The invention relates to a mobile handheld device that is capable of implementing VoIP over IP wireless networks, such as Wi-Fi or WiMAX, when connecting a WNIC to a peripheral receptacle hardwired to components of the handheld device. The handheld device of the invention differs from contemporary mobile handhelds in that a WNIC is not hardwired to the handheld. Instead, just the receptacle is hardwired. Another difference is that the cellular telecommunications circuitry for text, data, and voice can be omitted or optionally included. In one embodiment, the peripheral receptacle may be replaced with a wireless transceiver other than a WNIC, so that the WNIC may connect with the handheld wirelessly.

The receptacle is a standard PC Card wireless network interface controller receptacle, a proprietary PC Card wireless network interface controller receptacle, a PCMCIA, a standard A or B Universal Serial Bus (USB) receptacle, a mini A or B USB receptacle, a micro A or B USB receptacle, micro-AB OTG (i.e. USB On-The-Go) receptacle, a proprietary USB receptacle, or a miniaturized Peripheral Component Interconnect (PCI) expansion card receptacle (e g. Mini PCI/PCI Express Mini Card Slot), or any future receptacle that allows the insertion and removal of external WNIC cards or the like.

In addition to the receptacle, the mobile handheld device includes memory, software stored in the memory, and a processor that executes the software. In one embodiment, the software may be replaced by firmware or a combination of firmware and software. When the software and/or firmware is executed and the WNIC is connected to the mobile handheld, the handheld is capable of connecting to the Internet and providing VoIP communications. Additionally, the mobile handheld possibly includes other electrical components known in the art of mobile telephones that are coupled to the processor, such as a camera, a keypad, a display monitor, a touch screen, a speaker module, a microphone module, and a power supply module that includes a voltage conversion circuit.

### BRIEF DESCRIPTION OF THE DRAWINGS

FIG. 1 illustrates a block diagram of components of a mobile handheld electronic device that is manufactured without circuitry for facilitating telephonic communications, but is capable of receiving a WNIC that when connected facilitates VoIP telephonic communications, in accordance with a wired embodiment of the present invention.

FIG. 2 illustrates a block diagram of components of a mobile handheld electronic device that is manufactured without circuitry for facilitating telephonic communications, but is capable of receiving wirelessly a WNIC that when connected wirelessly facilitates VoIP telephonic communications, in accordance with a wireless embodiment of the present invention.

FIGS. 3A-8 illustrate exemplary mobile handheld electronic devices in accordance with embodiments of the present invention.

### DETAILED DESCRIPTION OF ILLUSTRATIVE EMBODIMENTS

The mobile handheld of the invention overcomes tradeoffs associated with hardwiring a WNIC to a mobile device. Such tradeoffs are overcome by manufacturing the mobile handheld without a WNIC hardwired to the handheld or by manufacturing the handheld with a detachable WNIC. In reference to “detachable,” the WNIC must be readily detachable by a regular user, where the user does not need to disassemble the handheld to any extent beyond pulling off the WNIC or, where a locking mechanism exists, unlocking the WNIC and then pulling it off. In other words, the mobile handheld is a cell phone or any other type of pocket-sized wireless device known in the art that does not have a WNIC or any other type of circuitry that facilitates telephonic communications hardwired to it, but is capable of VoIP once a WNIC is connected to it. Similar to contemporary cellular phones, preferably the handheld has a display screen combined with touch-screen input or combined with touch-screen input and a keypad (i.e. a miniaturized keyboard).

The handheld electronic device is designed to accommodate a connection to a PCI bus (e.g. WNIC), where the PCI bus is of the expansion card variety. Alternative embodiments of the handheld are designed to receive a WNIC in a USB connector, a miniaturized USB connector, a PC Card connector, a miniaturized PC card, a PCMCIA connector, a SIM connector, a SIP connector, or the like. The handheld electronic device accommodates the connection to a PCI bus via a receptacle such as a PCI card slot or receptacles that are capable of receiving the above-mentioned PCI buses. By connecting a WNIC (or another type of PCI bus that facilitates a wireless connection to the Internet) to the receptacle and running appropriate software or firmware for enabling VoIP, the handheld electronic device becomes VoIP ready, and becomes capable of connecting to IP wireless networks such as EVDO, HSDPA, Wi-Fi, WiMAX, or any other broadband IP-capable wireless network. Preferably, the handheld becomes a SIP client once a WNIC is connected. It is also preferred that the WNIC supports high-speed IP communications.

In addition to enabling VoIP, the above-mentioned software and/or firmware possibly enables inputting contact information into the user interface, storing contact information, searching contacts, selecting contacts on the user interface, initiating communication with a contact, switching the transport of voice communication data over various voice communication networks including the public switched telephone network (PSTN) and international telephone networks, secure communication where data is encrypted, transmission of data including data for instant messaging and/or text messaging, and/or storing instant messaging and/or text messaging history.

Where the handheld includes a video camera module and a display module, it is preferred that the software enables a version of SKYPE™ or any other software application that enables inputting contact information, storing contact information, searching contacts, selecting contacts, initiating communication with a contact, indicating online status of a contact, switching the transport of voice communication data over various networks including the PSTN and international telephone networks, transmission of data including data for instant messaging, storing instant messaging history, transmission of data including data for transferring of files and video conferencing, communication with a single user and with multiple users simultaneously, indication of contacts and users online status, group chats, emoticons, offline messages, editing of previously transmitted messages, video communication including full-screen and screen-in-screen modes, recording of voice and video communications, implementation of a peer-to-peer networking model, implementation of client-server networking model, audio and video data compression where the audio compression may include G.729 and SVOPC (Sinusoidal Voice Over Packet Coder) or SILK™ and an audio data compression algorithm that compresses packets of 10 msec duration, secure communication where data is encrypted and the encryption cannot be disabled and is invisible to users and where the encryption implementations include RSA algorithm for public-key negotiation and the Advanced Encryption Standard for encrypting voice communications, and/or providing an uncontrolled registration process for users with no proof of identity and identity is not revealed to other users. In such embodiments including audio compression, the audio compression is preferably enabled by a sinusoidal voice over packet coder and an audio data compression algorithm that compresses in packets of ten millisecond duration.

In embodiments that do not include a video camera module, the handheld may still implement several functions of a version of SKYPE™ or any other software application that has similar properties and functionality of SKYPE™.

The following paragraphs describe the appended drawings. The drawings that accompany this disclosure illustrate example embodiments of the mobile handheld of the invention.

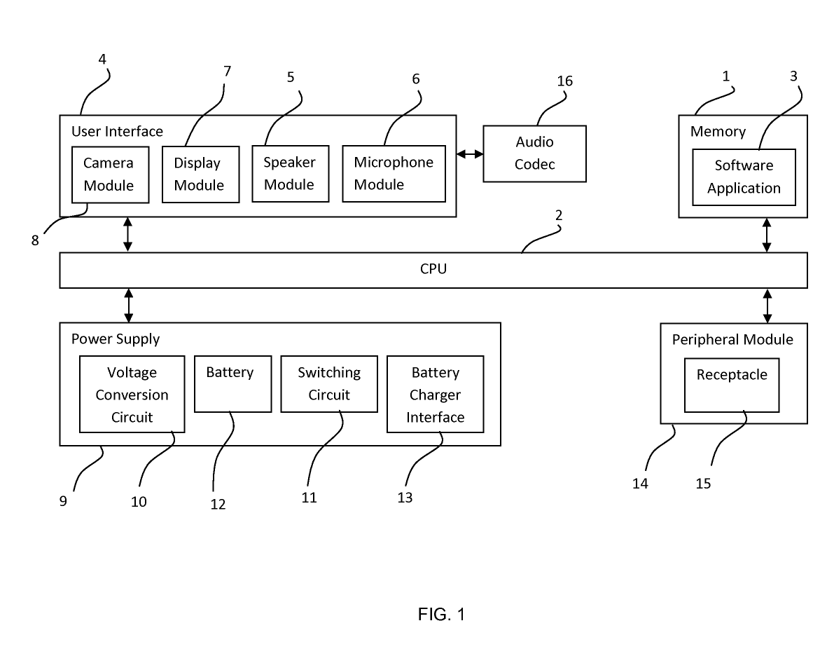

FIG. 1 illustrates a block diagram of components of an embodiment of the mobile handheld, including memory 1 and a processor 2, preferably a microprocessor, that executes software 3 stored in the memory 1, wherein the software 3 enables establishing voice communication over the Internet. FIG. 1 also includes a user interface 4 coupled with the processor 2 including a speaker module 5, a microphone module 6, a display module 7, and a video camera module 8. The user interface 4 interacts with an added audio codec 16, which enables encoding speech to be transmitted over a network as an audio stream. FIG. 1 also includes a power supply module 9 coupled with the processor 2 including a voltage conversion circuit 10, a circuit for switching between various power supplies 11, a battery 12, and a battery charger interface 13. FIG. 1 also includes at least one peripheral module 14 coupled with the processor 2 that includes a peripheral receptacle 15, where the peripheral receptacle 15 allows a WNIC to couple with the peripheral module 14.

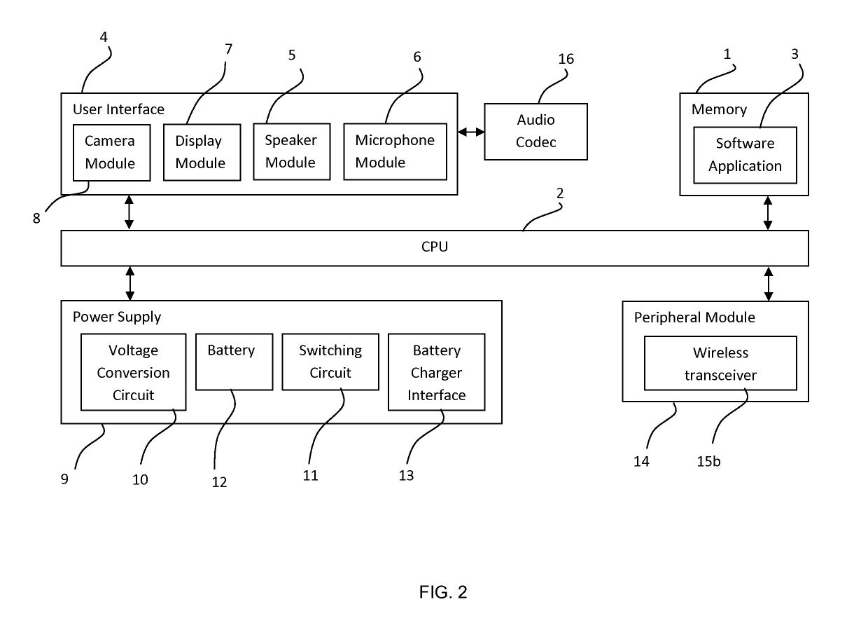

FIG. 2 illustrates a block diagram of the components of a handheld similar to the one shown in FIG. 1, except in FIG. 2 the peripheral receptacle 15 in FIG. 1 is replaced with a wireless transceiver 15b, so that a WNIC may connect with the handheld wirelessly.

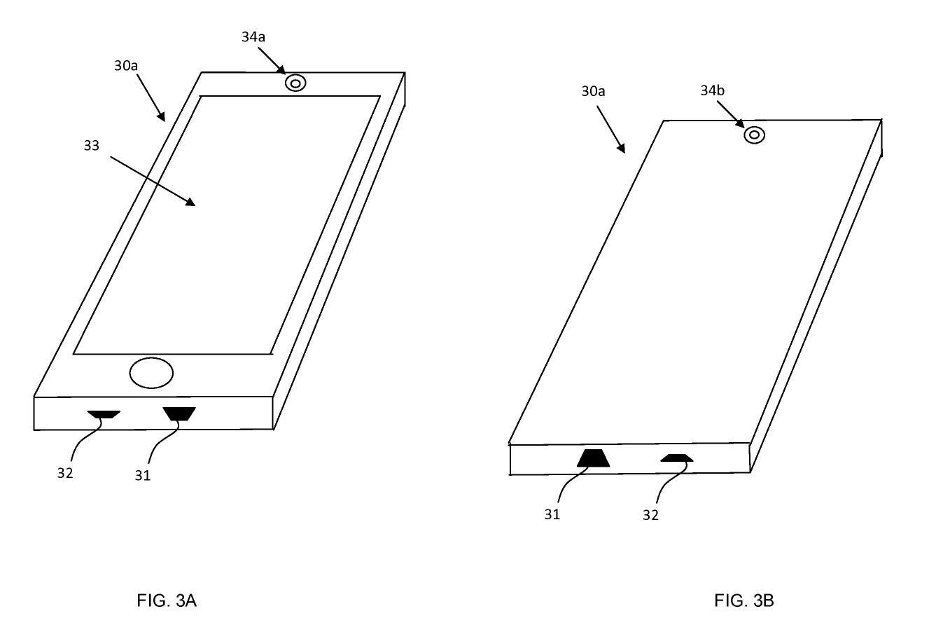

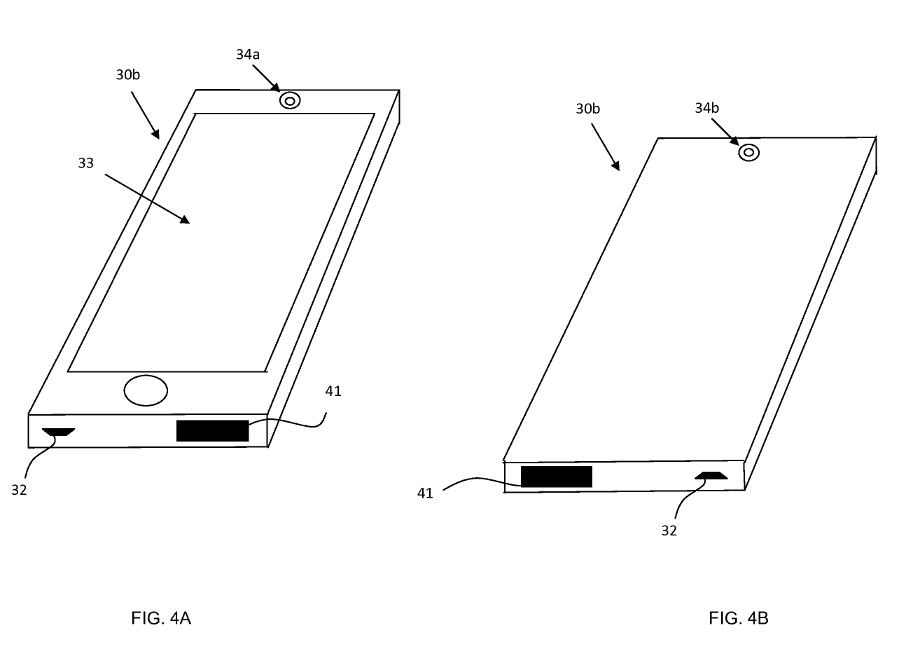

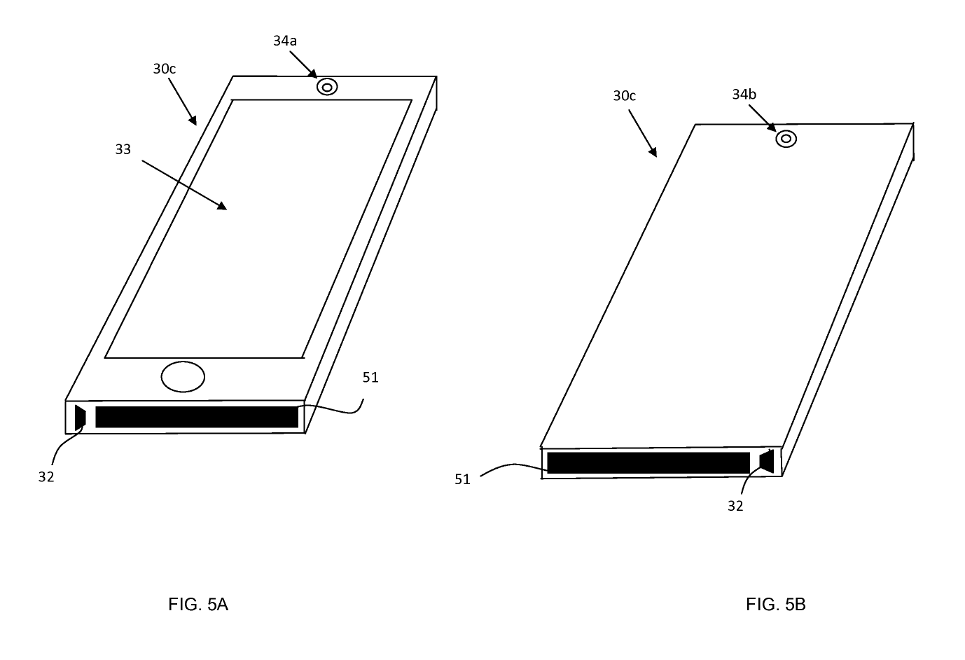

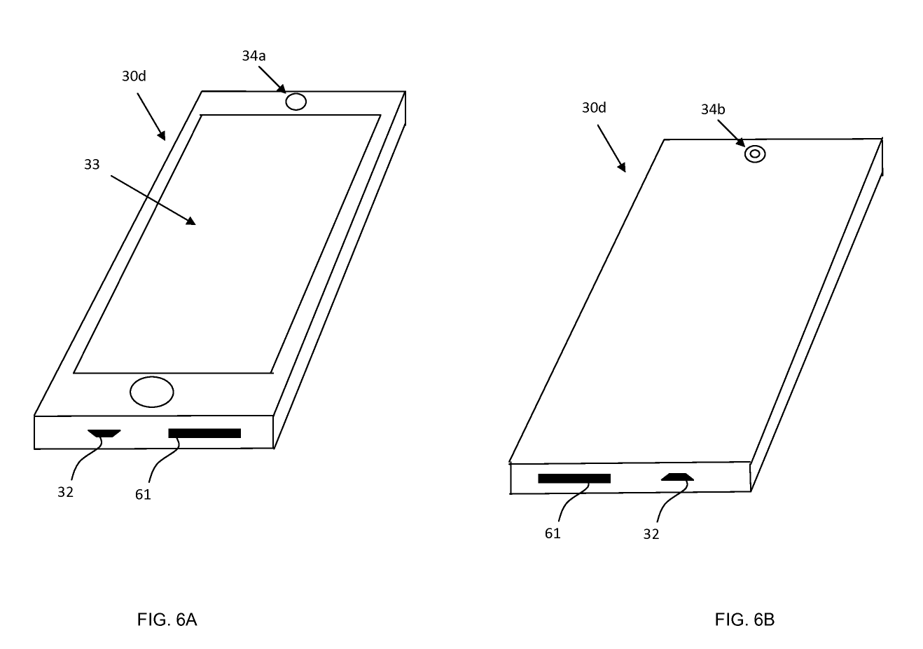

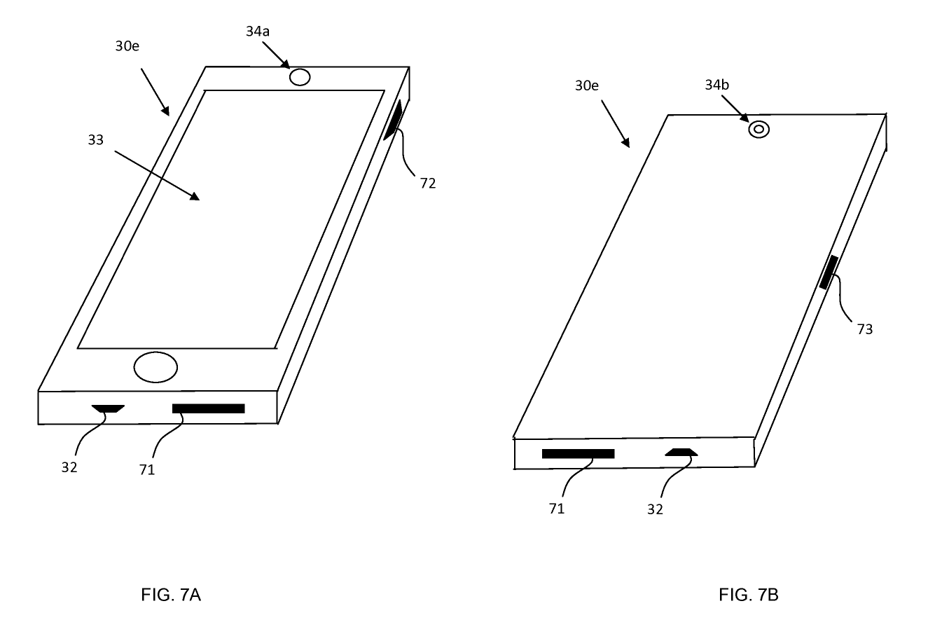

In general, FIGS. 3A-7B illustrate exemplary mobile handheld electronic devices 30a-30e, in accordance with embodiments of the present invention. The intent of FIGS. 3A-6B is to illustrate example shapes of the mobile handheld and how its form is possibly modified to receive various WNICs. It is not the intent of the figures to restrict aspects as claimed or to limit the number of embodiments described herein. In each illustration, the figures depict the arrangement of each handheld's display 33, preferably a touch-screen, front 34a and back 34b video and/or still cameras, power supply receptacle 32, and peripheral receptacles 31, 41, 51, or 61. The displays 33 and the front cameras 34a are facing in the same direction, which facilitates audio and video-based communications with another user over VoIP. For example, such arrangements facilitate video chat, and pertaining to embodiments of the handheld, such arrangements facilitate video chat over VoIP. More specifically, FIGS. 3A and 3B depict an embodiment of the handheld, where the peripheral receptacle 31 is capable of receiving a miniaturized USB connector. In FIGS. 4A and 4B, the peripheral receptacle 41 is capable of receiving a standard USB connector. In FIGS. 5A and 5B, the peripheral receptacle 51 is capable of receiving a PC Card wireless network interface controller. In FIGS. 6A and 6B, the peripheral receptacle 61 is capable of receiving a miniaturized PCI expansion card. In FIGS. 7A and 7B, multiple peripheral receptacles 71-73 are provided for receiving WNICs, so that in such embodiments various types of WNICs may be connected to the mobile handheld 30e.

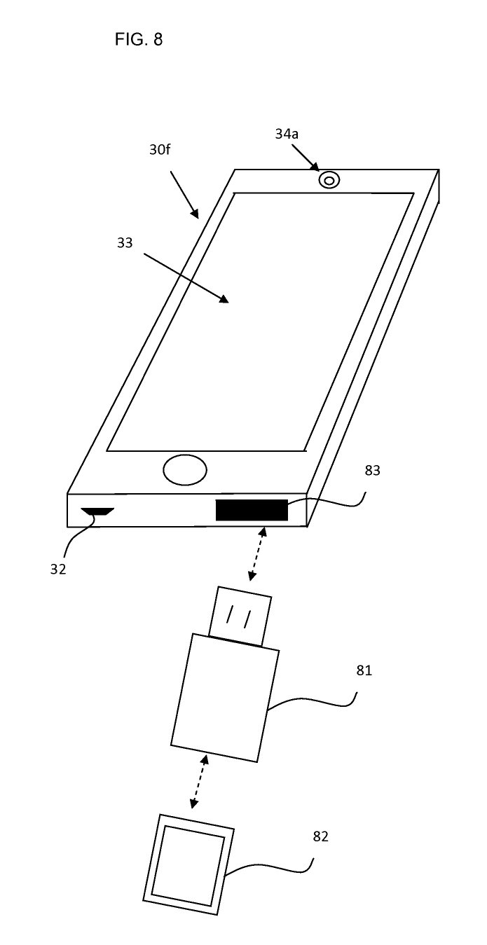

FIG. 8 illustrates an embodiment of the mobile handheld 30f where the peripheral receptacle 82 is plugged into the mobile handheld 30f through a connection adapter 81 (any connection adapter known to the art) which is between the mobile handheld 30f and the peripheral receptacle 82. As shown, the handheld 30f comprises a USB socket 83 or another type of socket known in the art, and the peripheral receptacle 82 is external to the handheld 30f.

Though various embodiments of the present invention have been described above, it should be understood that embodiments have been presented by way of example, and not limitation. A person of ordinary skill in the art will recognize that there are various changes that can be made to the present invention without departing from the spirit and scope of the present invention. Therefore, the invention should not be limited by any of the above-described example embodiments, but should be defined only in accordance with claims and equivalents of the claimed invention.

What is claimed:

1. A mobile handheld device manufactured without a wireless network interface controller and other cellular telecommunications circuitry for text, data, and voice, comprising:
a processor;
memory;
software stored in the memory; and
a peripheral receptacle coupled with the processor, the peripheral receptacle providing an interface for a self-contained wireless network interface controller (WNIC) that is external to the mobile handheld device to connect with the mobile handheld device, wherein as a result of the WNIC connecting to the mobile handheld device and the processor executing the software the mobile handheld device is capable of establishing voice over internet protocol (VoIP) communications over the Internet.

2. The mobile handheld device of claim 1, wherein the peripheral receptacle includes wireless transceiver circuitry that communicates with one or more external self-contained wireless network interface controllers incorporating wireless transceiver circuitry compatible with said wireless transceiver circuitry.

3. The mobile handheld device of claim 1, wherein the peripheral receptacle facilitates connection to at least one external self-contained WNIC.

4. The mobile handheld device of claim 1, wherein the peripheral receptacle is positioned on any face of the mobile handheld device.

5. The mobile handheld device of claim 1, further comprising a case for housing said processor, memory and peripheral receptacle.

6. The mobile handheld device of claim 1, wherein the peripheral receptacle is plugged into the mobile handheld device through a connection adapter disposed between the mobile handheld device and the peripheral receptacle.

7. The mobile handheld device of claim 1, wherein the peripheral receptacle facilitates connecting one or more of the following external self-contained WNICs to the mobile handheld device:
Universal serial bus wireless network interface controller;
PC card wireless network interface controller;
PCMCIA wireless network interface controller;
SIM wireless network interface controller;
SIP wireless network interface controller;
Miniaturized universal serial bus wireless network interface controller; and
Miniaturized PC card wireless network interface controller.

8. The mobile handheld device of claim 1, further comprising a display and a video camera facing in the same direction as the display.

9. The mobile handheld device of claim 1, wherein the software, when executed by the processor, further facilitates at least one of:
transmission of data for video conferencing;
video communication comprising full-screen and screen-in-screen modes;
inputting contact information;
storing contact information in the memory;
searching contacts;
selecting a contact;
initiating communication with a contact;
switching between voice communication networks, including the public switched telephone network and international telephone networks;
securing communication through data encryption;
transmitting data, including data for instant messaging and texting;
storing instant messaging and text messaging history;
indicating online status of a contact;
communicating with multiple users simultaneously;
editing of previously transmitted messages;
switching between peer-to-peer networking and client-server networking;
audio and video data compression, where the audio compression includes a sinusoidal voice over packet coder and an audio data compression algorithm that compresses in packets of ten millisecond duration;
a secure communication where data is encrypted and the encryption cannot be disabled and is invisible to users, where the encryption includes a RSA algorithm for public-key negotiation and the Advanced Encryption Standard for encrypting voice communications; and
an uncontrolled registration process for users with no proof of identity and identity is not revealed to other users.
